(19) United States
(12) Patent Application Publication
(10) Pub. No.: US 2011/0283079 A1
(43) Pub. Date: Nov. 17, 2011

(54) DATA PROCESSING DEVICE APPLYING FOR STORAGE DEVICE, DATA ACCESSING SYSTEM AND RELATED METHOD

(76) Inventors: Shu-Yi Lin, Taipei County (TW); Hsu-Ting Chien, Taichung County (TW); Chun-Hung Kuo, Hsinchu City (TW)

(21) Appl. No.: 12/855,702

(22) Filed: Aug. 13, 2010

(30) Foreign Application Priority Data
May 11, 2010 (TW) 099114950

(51) Int. Cl. G06F 12/02; G06F 12/00

(52) U.S. Cl. 711/170; 711/E12.001; 711/E12.002

(57) ABSTRACT

A data processing device applying for a storage device includes: a first interface circuit coupled to the storage device; a processing circuit coupled to the first interface circuit for reading a control code from a divided storage area in the storage device, and executing the control code to generate a storage capacity of the storage device; and a second interface circuit coupled to the processing circuit for feeding the storage capacity back to an operating system such that the operating system regards the storage capacity as a usable capacity of the storage device.

### BACKGROUND OF THE INVENTION

1. Field of the Invention

The present invention relates to a data processing device applying for a storage device and a data accessing system and related method, and more particularly to a data processing device and a data accessing system capable of saving at least one additional memory and a related method.

2. Description of the Prior Art

A storage device driving circuit is operable to access data in a storage device according to a command outputted from a host. As the data format between the storage device driving circuit and the storage device may be different from that between the storage device driving circuit and the host, the storage device driving circuit may need to perform a data format conversion such that the data can be transmitted between the host and the storage device. For an example of a universal serial bus (USB) 2.0 external hard disk device, the data format of the data transmitted between the storage device (i.e., the hard disk device) and the storage device driving circuit may conform to the serial advanced technology attachment (SATA) specification, but the data format of the data transmitted between the storage device driving circuit and the host may conform to the USB 2.0 specification, therefore the storage device driving circuit should perform a data format conversion between the data conforming to the SATA specification and the data conforming to the USB 2.0 specification such that the data can be transmitted between the host and the hard disk device.

Normally, the storage device driving circuit may further include an additional memory device for storing the control code of the storage device driving circuit and some hard disk related information. However, the control code of the storage device driving circuit and the hard disk related information may become more complex when advanced technology is introduced to fabricate the storage device driving circuit and the storage device. In this case, the capacity of the control code of the storage device driving circuit and the hard disk related information become larger and the additional memory device should be changed to another memory device having a larger capacity. In other words, the cost of the above-mentioned conventional solution is increased since the additional memory device should be changed to another memory device having a larger capacity when advanced technology is introduced to fabricate the storage device driving circuit and the storage device. Therefore, providing an efficient and convenient way to reduce the cost of the storage device driving circuit becomes a significant concern in this field.

### SUMMARY OF THE INVENTION

One of the objectives of the present invention is to therefore provide a data processing device and a data accessing system capable of saving at least one additional memory, and a related method.

According to a first embodiment of the present invention, a data processing device applying for a storage device is disclosed. The data processing device comprises a first interface circuit, a processing circuit, and a second interface circuit. The first interface circuit is coupled to the storage device. The processing circuit is coupled to the first interface circuit for reading a control code from a divided storage area in the storage device, and executing the control code to generate a storage capacity of the storage device. The second interface circuit is coupled to the processing circuit for feeding the storage capacity back to an operating system such that the operating system regards the storage capacity as a usable capacity of the storage device.

According to a second embodiment of the present invention, a data accessing system is disclosed. The data accessing system comprises a storage device and a data processing device. The storage device has a divided storage area and a normal data storage area that is different from the divided storage area, wherein the divided storage area stores a control code. The data processing device comprises a first interface circuit, a processing circuit, and a second interface circuit. The first interface circuit is coupled to the storage device. The processing circuit is coupled to the first interface circuit for reading a control code from a divided storage area, and executing the control code to generate a storage capacity of the storage device. The second interface circuit is coupled to the processing circuit for feeding the storage capacity back to an operating system such that the operating system regards the storage capacity as a usable capacity of the storage device.

According to a third embodiment of the present invention, a data processing method applying for a storage device is disclosed. The data processing method comprises: reading a control code from a divided storage area in the storage device; executing the control code to generate a storage capacity of the storage device; and feeding the storage capacity back to an operating system such that the operating system regards the storage capacity as a usable capacity of the storage device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a data accessing system according to an embodiment of the present invention.

FIG. 2 is a diagram illustrating a storage device according to an embodiment of the present invention.

FIG. 3 is a flowchart illustrating a data processing method applying for a storage device according to an embodiment of the present invention.

### DETAILED DESCRIPTION

Certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

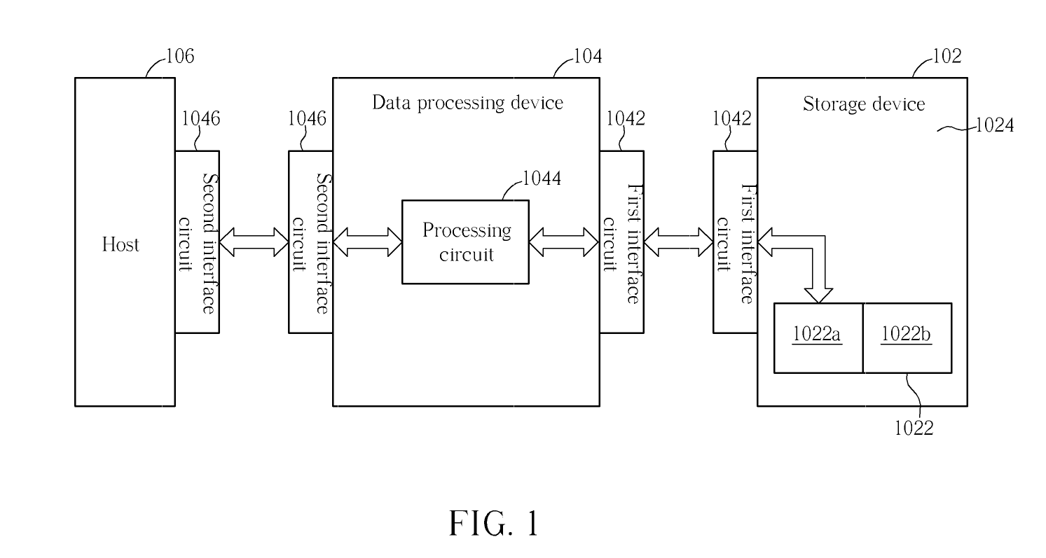

Please refer to FIG. 1. FIG. 1 is a diagram illustrating a data accessing system 100 according to an embodiment of the present invention. The data accessing system 100 comprises a storage device 102, a data processing device 104, and a host 106. In this embodiment, the host 106 can be represented by a computer system, and the storage device 102 and the data processing device 104 are an external storage device which is externally coupled to the computer system. Normally, a conventional external storage device requires an additional memory for storing a correctable control code and information related to the external storage device. The present invention, however, stores the correctable control code and the information related to the external storage device into a hidden area of the storage device 102 to save the additional memory. Therefore, the present data processing device 104 at least has the advantages of saving a memory (i.e., the additional memory). The detailed practice is described in the following paragraphs.

The present storage device 102 is divided into a divided storage area 1022 and a normal data storage area 1024 that is different from the divided storage area 1022, wherein the divided storage area 1022 stores a correctable control code 1022a and a hard disk information 1022b related to the storage device 102. For example, the correctable control code 1022a can be a program for providing a specific function to a user, and the hard disk information 1022b can be the recorded information of the storage device 102 or the manufacturer related information (e.g. PID, VID). The data processing device 104 comprises a first interface circuit 1042, a processing circuit 1044, and a second interface circuit 1046. The first interface circuit 1042 is coupled to the storage device 102. The processing circuit 1044 is coupled to the first interface circuit 1042 for reading the correctable control code 1022a from the divided storage area 1022, and executing the correctable control code 1022a to generate a storage capacity of the storage device 102, wherein the storage capacity is equal to a capacity of the divided storage area 1022 subtracted from a total capacity of the storage device 102. The second interface circuit 1046 is coupled to the processing circuit 1044 for feeding the storage capacity back to an operating system of the host 106 such that the operating system regards the storage capacity as a usable capacity of the storage device 102. Please note that the present processing circuit 1044 may execute the correctable control code 1022a to further repair the incomplete firmware in the processing circuit 1044, or execute the correctable control code 1022a to provide the related information of the hard disc (e.g., the storage device 102).

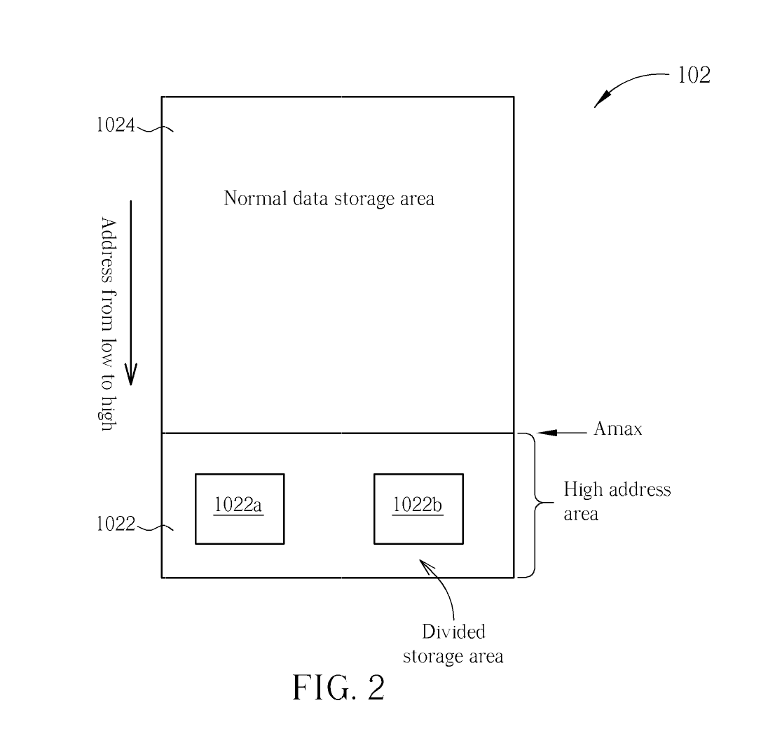

More specifically, when the storage device 102 has the hidden area (i.e., the divided storage area 1022), the processing circuit 1044 of the data processing device 104 further executes the correctable control code 1022a to control the operating system to only access the normal data storage area 1024 in the storage device 102 that is different from the divided storage area 1022 when the operating system needs to access the storage device 102. Therefore, the divided storage area 1022 is hidden from the host 106, and thus the host 106 is not able to access the divided storage area 1022 via the data processing device 104. Furthermore, it should be noted that the present invention does not limit that the divided storage area 1022 and the normal data storage area 1024 are two adjacent storage areas; the divided storage area 1022 and the normal data storage area 1024 can also be two storage areas that are not adjacently coupled with each other. Therefore, the processing circuit 1044 executes the correctable control code 1022a to feed a usable address range corresponding to the normal data storage area 1024 in the storage device 102 back to the operating system such that the operating system regards the storage capacity as a usable capacity of the storage device 102. For an illustration of this, please refer to FIG. 2. FIG. 2 is a diagram illustrating the storage device 102 according to an embodiment of the present invention. When the divided storage area 1022 is defined to belong to the area having the high address area in the storage device 102, the processing circuit 1044 allocates the capacities of the divided storage area 1022 and the normal data storage area 1024 according to the sizes of the correctable control code 1022a and the hard disk information 1022b related to the storage device 102, and then feeds the largest usable address Amax of the normal data storage area 1024 back to the operating system. In other words, the largest usable address Amax will be smaller than all of the addresses of the divided storage area 1022. Therefore, when the data accessing system 100 is under operation, the operating system is not able to access the data of the divided storage area 1022 since the addresses of the normal data storage area 1024 are smaller than the addresses of the divided storage area 1022. Accordingly, the data stored in the divided storage area 1022 is under protection since the divided storage area 1022 is hidden from the operating system. Furthermore, it should be noted that the divided storage area 1022 can be defined to be any area in the storage device 102: for example, the divided storage area 1022 can be defined to belong to the area having the low address area in the storage device 102. Briefly, when the divided storage area 1022 is defined to belong to a specific address range in the storage device 102, the processing circuit 1044 first performs an operation (e.g., an address conversion operation) to process the specific address range, and then feeds an output corresponding to the specific address range back to the operating system. Then, when the operating system transmits a command to the storage device 102, the processing circuit 1044 will perform another operation (e.g., another address conversion operation) upon the target address of the command to generate a real target address of the command, in which the real target address will not be pointed to the divided storage area 1022. Therefore, any other methods that are able to control the command generated by the operating system to not access the data in the divided storage area 1022 also belong to the scope of the present invention. More specifically, the present processing circuit 1044 does not necessarily physically divide the storage device 102 into the divided storage area 1022 and the normal data storage area 1024: the processing circuit 1044 may virtually divide the storage device 102 into the divided storage area 1022 and the normal data storage area 1024 by executing a software program, which also belongs to the scope of the present invention.

Please note that the capacity of the divided storage area 1022 is adjustable since the divided storage area 1022 is divided among the storage device 102. In other words, the processing circuit 1044 adjusts the capacity of the divided storage area 1022 according to the sizes of the correctable control code 1022a and the hard disk information 1022b related to the storage device 102 in order to not waste the capacity of the storage device 102. In comparison, the capacity of the additional memory employed in the conventional way is not adjustable after the additional memory is installed into the storage device driving circuit. Accordingly, the capacity of the conventional additional memory may be insufficient if the sizes of the control code of the storage device driving circuit and the hard disk related information are too large, or some area in the conventional additional memory may be left unused if the sizes of the control code of the storage device driving circuit and the hard disk related information are too small.

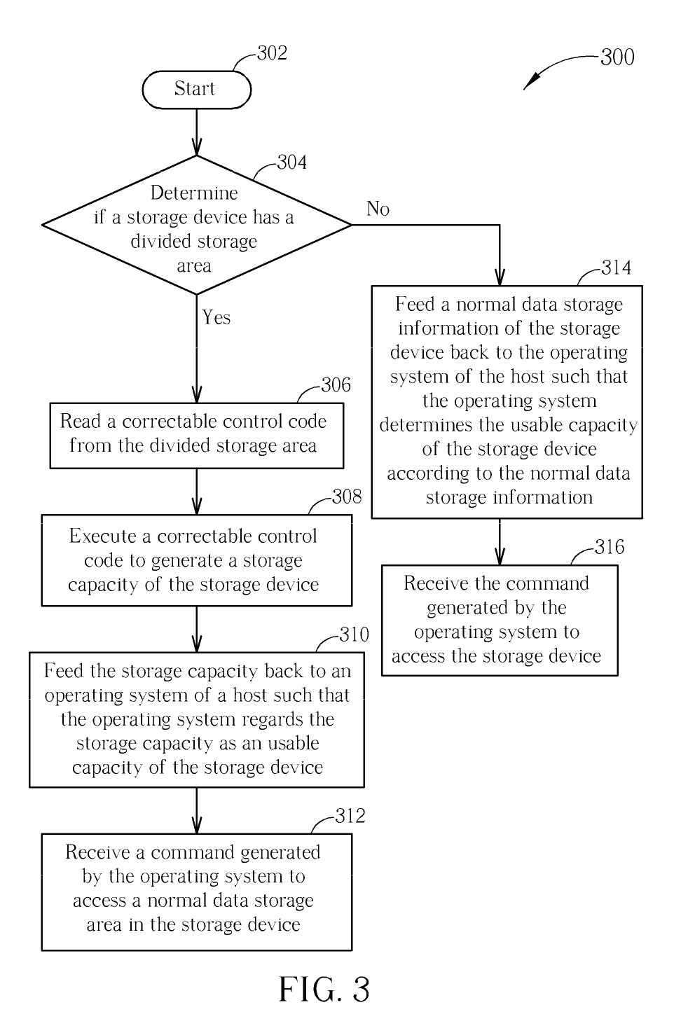

Please refer to FIG. 3. FIG. 3 is a flowchart illustrating a data processing method 300 applying for a storage device according to an embodiment of the present invention. The data processing method 300 can be implemented by the above-mentioned processing circuit 1044, but is not a limitation of the present invention. Therefore, to more clearly illustrate the features of the data processing method 300, the data processing method 300 is described in conjunction with the above-mentioned storage device 102 and the data processing device 104. Furthermore, provided that substantially the same result is achieved, the steps of the flowchart shown in FIG. 3 need not be in the exact order shown and need not be contiguous; that is, other steps can be intermediate. The data processing method 300 comprises the following steps:

Step 302: Start;

Step 304: Determine if the storage device 102 has the divided storage area 1022; when the storage device 102 has the divided storage area 1022, go to step 306; when the storage device 102 does not have the divided storage area 1022, go to step 314;

Step 306: Read the correctable control code 1022a from the divided storage area 1022;

Step 308: Execute the correctable control code 1022a to generate the storage capacity of the storage device 102, wherein the storage capacity is equal to a capacity of the divided storage area 1022 subtracted from the total capacity of the storage device 102;

Step 310: Feed the storage capacity back to the operating system of the host 106 such that the operating system regards the storage capacity as the usable capacity of the storage device 102;

Step 312: Receive the command generated by the operating system to access the normal data storage area 1024 in the storage device 102;

Step 314: Feed a normal data storage information of the storage device 102 back to the operating system of the host 106 such that the operating system determines the usable capacity of the storage device 102 according to the normal data storage information;

Step 316: Receive the command generated by the operating system to access the storage device 102.

When the data accessing system 100 is started up, the processing circuit 1044 may not acknowledge if the correctable control code 1022a and the hard disk information 1022b related to the storage device 102 are stored in the divided storage area 1022 of the storage device 102 or stored in an additional memory. Therefore, the processing circuit 1044 first determines if the storage device 102 has the divided storage area 1022 in step 304. When the storage device 102 has the divided storage area 1022, the processing circuit 1044 reads the correctable control code 1022a from the divided storage area 1022 in step 306. When the storage device 102 does not have the divided storage area 1022, the processing circuit 1044 determines that the correctable control code 1022a and the hard disk information 1022b related to the storage device 102 are stored in the additional memory. In step 308, the processing circuit 1044 executes the correctable control code 1022a to generate the storage capacity of the storage device 102, and feeds the storage capacity back to the operating system of the host 106 such that the operating system regards the storage capacity as the usable capacity of the storage device 102. Accordingly, the processing circuit 1044 only accesses the normal data storage area 1024 in the storage device 102 that is different from the divided storage area 1022 when the operating system needs to access the storage device 102 in step 312. Therefore, the divided storage area 1022 is hidden from the host 106, and thus the host 106 is not able to access the divided storage area 1022 via the data processing device 104. When the storage device 102 does not have the divided storage area 1022, the processing circuit 1044 feeds the normal data storage information of the storage device 102 back to the operating system of the host 106 such that the operating system determines the usable capacity of the storage device 102 (e.g., the total capacity of the storage device 102) according to the normal data storage information in step 314. Then, the processing circuit 1044 receives the command generated by the operating system to access the storage device 102 in step 316.

Please note that the present invention does not limit the host 106 to a specific type of host: the host 106 can be a computer, a laptop, or a microprocessor. Furthermore, the present invention also does not limit the storage device 102 to a specific type of storage device: the storage device 102 can be a hard disk, a flash memory disk, a solid state disk, or a magnetic storage disk. In addition, the present invention also does not limit the first interface circuit 1042 and the second interface circuit 1046 to a specific type of interface circuit. The second interface circuit 1046 communicates to the host 106 according to a specific data transmission specification, and the specific data transmission specification conforms to a universal serial bus (USB) 2.0 specification, a USB 3.0 specification, a serial advanced technology attachment (SATA) specification, or an external serial advanced technology attachment (eSATA) specification. Similarly, the first interface circuit 1042 communicates to the storage device 102 according to a specific data transmission specification, and the specific data transmission specification conforms to the USB 2.0 specification, the USB 3.0 specification, the SATA specification, or the eSATA specification.

In addition, even though the features of the present data accessing system 100 are described in accordance with an external storage device, this is not meant to be a limitation of the present invention. A similar technique can also be applied to an embedded storage device in a data accessing system, and this also belongs to the scope of the present invention.

Briefly, the present invention stores the correctable control code 1022a and the hard disk information 1022b related to the storage device 102 into a hidden area (i.e., the divided storage area 1022) of the storage device 102 to at least save the additional memory. Furthermore, the processing circuit 1044 is employed to control the data transmission between the host 106 and the storage device 102 such that the data stored in the divided storage area 1022 is hidden from the host 106.

Those skilled in the art will readily observe that numerous modifications and alterations of the device and method may be made while retaining the teachings of the invention.

What is claimed is:

1. A data processing device applying for a storage device, comprising:
a first interface circuit, coupled to the storage device;
a processing circuit, coupled to the first interface circuit, for reading a control code from a divided storage area in the storage device, and executing the control code to generate a storage capacity of the storage device; and
a second interface circuit, coupled to the processing circuit, for feeding the storage capacity back to an operating system such that the operating system regards the storage capacity as a usable capacity of the storage device.

2. The data processing device of claim 1, wherein the storage capacity is equal to a capacity of the divided storage area subtracted from a total capacity of the storage device, and the processing circuit further executes the control code to control the operating system to only access a normal data storage area in the storage device that is different from the divided storage area when the operating system needs to access the storage device.

3. The data processing device of claim 2, wherein the processing circuit executes the control code to feed a usable address range corresponding to the normal data storage area in the storage device back to the operating system.

4. The data processing device of claim 1, wherein the processing circuit further determines if the storage device has the divided storage area, and the processing circuit reads the control code stored in the divided storage area if the processing circuit determines that the storage device has the divided storage area.

5. The data processing device of claim 1, wherein the storage device is a hard disk, a flash memory disk, a solid state disk, or a magnetic storage disk.

6. The data processing device of claim 1, wherein the second interface circuit communicates to a host according to a specific data transmission specification, and the specific data transmission specification is a universal serial bus (USB) 2.0 specification, a USB 3.0 specification, a serial advanced technology attachment (SATA) specification, or an external serial advanced technology attachment (eSATA) specification.

7. A data accessing system, comprising:
a storage device, having a divided storage area and a normal data storage area that is different from the divided storage area, wherein the divided storage area stores a control code; and
a data processing device, comprising:
a first interface circuit, coupled to the storage device;
a processing circuit, coupled to the first interface circuit, for reading a control code from a divided storage area, and executing the control code to generate a storage capacity of the storage device; and
a second interface circuit, coupled to the processing circuit, for feeding the storage capacity back to an operating system such that the operating system regards the storage capacity as a usable capacity of the storage device.

8. The data accessing system of claim 7, wherein the divided storage area further stores hardware information of the storage.

9. The data accessing system of claim 7, wherein the storage device and the data processing device are installed in an external storage device.

10. The data accessing system of claim 9, wherein the storage device is a hard disk, a flash memory disk, a solid state disk, or a magnetic storage disk.

11. The data accessing system of claim 7, wherein the storage device is a hard disk, a flash memory disk, a solid state disk, or a magnetic storage disk.

12. A data processing method applying for a storage device, comprising:
reading a control code from a divided storage area in the storage device;
executing the control code to generate a storage capacity of the storage device; and
feeding the storage capacity back to an operating system such that the operating system regards the storage capacity as a usable capacity of the storage device.

13. The data processing method of claim 12, wherein the storage capacity is equal to a capacity of the divided storage area subtracted from a total capacity of the storage device, and the processing method further comprises:
executing the control code to control the operating system to only access a normal data storage area in the storage device that is different from the divided storage area when the operating system needs to access the storage device.

14. The data processing method of claim 13, wherein the step of executing the control code to control the operating system to only access the normal data storage area in the storage device that is different from the divided storage area when the operating system needs to access the storage device comprises:
executing the control code to feed a usable address range corresponding to the normal data storage area in the storage device back to the operating system.

15. The data processing method of claim 12, further comprising:
determining if the storage device has the divided storage area; and
reading the control code stored in the divided storage area if the storage device is determined to have the divided storage area.
